(19) United States
(12) Patent Application Publication
(10) Pub. No.: US 2019/0288515 A1
(43) Pub. Date: Sep. 19, 2019

(54) POWER CONDITIONER

(71) Applicant: OMRON Corporation, Kyoto (JP)

(72) Inventors: Shunsuke NISHI, Kyoto-shi (JP); Yusuke OUCHI, Kyoto-shi (JP)

(73) Assignee: OMRON Corporation, Kyoto (JP)

(21) Appl. No.: 16/275,337

(22) Filed: Feb. 14, 2019

(30) Foreign Application Priority Data
Mar. 14, 2018 (JP) 2018-046669

(51) Int. Cl. H02J 3/38; H02H 7/20; H02H 1/00

(52) U.S. Cl. CPC H02J 3/383; H02H 1/0007; H02H 7/20

(57) ABSTRACT

In the power conditioner having a step-up chopper connected to a plurality of solar cell strings, when a current flowing in the reverse direction from the normal direction due to a short circuit fault of any step-up chopper is detected, a relay is opened, and an inverter is stopped. A gate of an IGBT of the step-up chopper where a short circuit fault has occurred is turned off. Solar cell strings are controlled in a way that at least any of power, a voltage and a current input to a solar cell string is set as less than or equal to a predetermined threshold value.

### CROSS-REFERENCE TO RELATED APPLICATION

This application claims the priority benefit of Japan Application No. 2018-046669, filed on Mar. 14, 2018. The entirety of the above-mentioned patent application is hereby incorporated by reference herein and made a part of this specification.

### BACKGROUND

### Technical Field

The present disclosure relates to a power conditioner.

### Description of Related Art

Conventionally, a power conditioner converting direct current power from a solar cell into alternating current power of a commercial frequency connected to a system is used in a solar power system. Further, solar cell strings formed by direct connection body of a group of solar cell panels are connected in parallel in the power conditioner in a multi-input type of a solar power system. In the power conditioner of such a multi-input type of the solar power system, when a malfunction occurs in a circuit connected to a string, and a current flowing in the reverse direction from the normal direction is allowed, power is input from other strings to a solar cell connected to the circuit in which the malfunctioned has occurred. In the case where the power that is input is excessive, the solar cell connected to the circuit may be damaged by heat generation. In such a case, a power conditioner has been proposed to prevent a current from flowing from circuits connected to other strings to the circuit in which the malfunction has occurred by turning off a switching element provided in the circuit in which the malfunction has occurred and turning on switching elements provided in the circuits connected to the other strings (e.g., see Patent Document 1).

According to the above-mentioned conventional technology, although damage caused by heat generation of a solar cell can be prevented, there is a disadvantage that power from other solar cells cannot be used.

### PATENT DOCUMENT(S)

[Patent Document 1] Japanese Patent No. 6181578

### SUMMARY

The present disclosure provides a power conditioner including: a first DC/DC converter connected to a first solar cell; a converter set, being respectively connected to the first solar cell and other solar cells different from the first solar cell and including at least one DC/DC converter connected in parallel with the first DC/DC converter; and a control apparatus, controlling the first DC/DC converter and the DC/DC converter of the converter set, wherein when a current flowing in the reverse direction from the normal direction is detected in the first DC/DC converter, the control apparatus controls the DC/DC converter of the converter set in a way that at least any of power, a voltage or a current in the first solar cell that is input from the converter set is set as less than or equal to a predetermined first threshold value.

### BRIEF DESCRIPTION OF THE DRAWINGS

FIG. 1 is a schematic diagram of a solar power system including a power conditioner according to an embodiment of the present disclosure.

FIG. 2 is a circuit diagram illustrating a configuration of a step-up chopper according to an embodiment of the present disclosure.

FIG. 3 is a flowchart illustrating control according to an embodiment of the present disclosure.

FIG. 4 is a flowchart of a protective operation 1 subroutine according to an embodiment of the present disclosure.

FIG. 5 is a flowchart of a protective operation 2 subroutine according to an embodiment of the present disclosure.

FIG. 6 is a flowchart of a protective operation 3 subroutine according to an embodiment of the present disclosure.

### DESCRIPTION OF THE EMBODIMENTS

The present disclosure provides a technology capable of preventing damage to a solar cell connected to a circuit in which a malfunction has occurred and using power from other solar cells in a power conditioner connected to a plurality of solar cells.

According to the present disclosure, even though the current flows in the reverse direction from the normal direction in the first solar cell connected to the first DC/DC converter in which a malfunction has occurred, by setting the power, the voltage or the current input from the converter set as less than or equal to the predetermined first threshold value, damage to the first solar cell can be prevented, and power from the other solar cells different from the first solar cell connected to the converter set can be used. Particularly, in the case where a power supply of the control apparatus has been obtained from the DC/DC converters, output from the DC/DC converters of the converter set can be used as a control power supply, and an operation of the control apparatus can be prevented from becoming unstable.

Further, the first DC/DC converter and the DC/DC converters of the converter set convert direct current power of a solar cell to other direct current power. The first DC/DC converter and the DC/DC converters of the converter set are not limited to a step-up chopper, which include other circuits such as step-down choppers that convert direct current power into direct current power. The converter set includes at least one DC/DC converter connected to the other solar cells different from the first solar cell. That is, there may be one DC/DC converter included in the converter set, or a plurality of DC/DC converters respectively connected to a plurality of other solar cells different from the first solar cell. A current value is set based on standards that includes not only the case that the current flowing in the reverse direction from the normal direction is detected, but also the case that the current flowing in the reverse direction is detected to reach greater than or equal to a predetermined value.

Further, in the present disclosure, in the case where the current flowing in the reverse direction from the normal direction is detected in the first DC/DC converter, the control apparatus may control the DC/DC converters of the converter set in a way that the power or the voltages in the first solar cell that are output from the solar cells connected to the DC/DC converter of the converter set respectively are set as less than or equal to a predetermined second threshold value respectively.

According to the present disclosure, by performing control according to properties of the solar cells respectively connected to the DC/DC converters connected to the converter set, damage to the first solar cell can be prevented, and power from the solar cells connected to the converter set can be used. Herein, when there are a plurality of DC/DC converters included in the converter set, the predetermined second threshold value can be set differently according to each of the solar cells connected to the DC/DC converters respectively.

Further, in the present disclosure, the DC/DC converters of the converter set respectively have switching elements controlled to be turned on and off depending on a control signal from the control apparatus, wherein when the current flowing in the reverse direction from the normal direction is detected in the first DC/DC converter, the control apparatus may perform control in a way that duty ratios of the control signals output from the control apparatus to each switching element are set as less than or equal to a predetermined third threshold value respectively.

According to the present disclosure, even though the current flows in the reverse direction from the normal direction in the first solar cell connected to the first DC/DC converter in which a malfunction has occurred, by setting the duty ratios of the control signals output to the switching elements as the predetermined third threshold value, damage to the first solar cell can be prevented, and power from the solar cells connected to the DC/DC converters of the converter set can be used. Particularly, in the case where a power supply of the control apparatus has been obtained from the DC/DC converters, output from the DC/DC converters of the converter set can be used as a control power supply, and an operation of the control apparatus can be prevented from becoming unstable. Herein, when there are a plurality of DC/DC converters included in the converter set, the third threshold value can be set differently according to each switching element of the DC/DC converters.

Herein, the switching element turns on and off a switch for power conversion by the DC/DC converter. The switching element may be, for example, a IGBT, an MOS-FET, an SiC transistor or a GaN transistor.

In addition to the first DC/DC converter and the DC/DC converters included in the converter set, the power conditioner of the present disclosure also includes DC/DC converters connected to other solar cells different from the first solar cell. For example, except for the converter set, there may be DC/DC converters configured to always turn on the switching element or always turn off the switching element (when a short circuit occurs).

In the present disclosure, the first DC/DC converter may have a first switching element controlled to be turned on and off depending on the control signal from the control apparatus, wherein when the current flowing in the reverse direction from to normal direction is detected in the first DC/DC converter, the control apparatus may turn off the first switching element.

Further, in the present disclosure, an inverter converting direct current power output from the first DC/DC converter and the DC/DC converters of the converter set into alternating current power is included, and when the current flowing in the reverse direction from the normal direction is detected in the first DC/DC converter, the control apparatus may stop the inverter.

In addition, in the present disclosure, a turn-on and turn-off part for turning on and off the inverter and a circuit connected to a commercial power supply or a load is included, and when the current flowing in the reverse direction from the normal direction is detected in the first DC/DC converter, the control apparatus may open the turn-on and turn-off part.

According to the present disclosure, in the power conditioner connected to the plurality of solar cells, there may be provided a technology capable of preventing damage to a solar cell connected to a circuit in which a malfunction has occurred and using power from other solar cells.

### Application Example

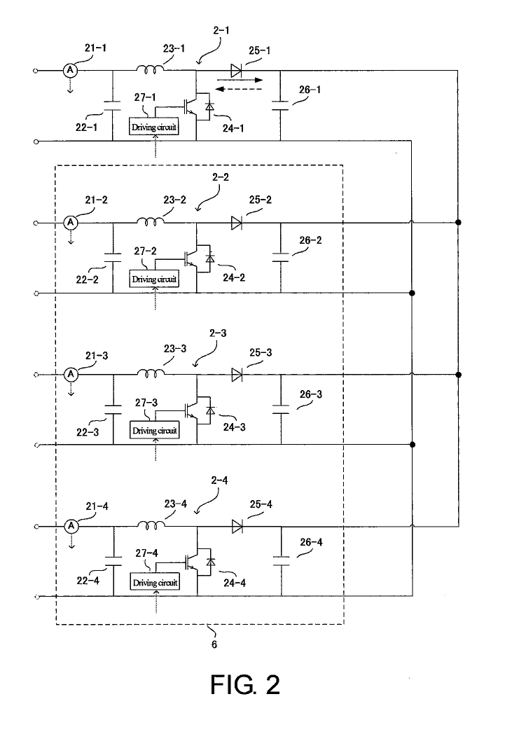

Application examples of the present disclosure will be described below with reference to the drawings. The present disclosure is, for example, applicable to a power conditioner including step-up choppers 2-1 to 2-4 that is an example of DC/DC converters connected in parallel as shown in FIG. 2. In the step-up chopper 2-1, although a current normally flows in a direction of arrows indicated in solid lines by a reflux diode 25-1, when a short circuit fault occurs in the reflux diode 25-1, the current may flow in the reverse direction from the normal direction as shown in arrows indicated in broken lines. For a solar cell connected to the step-up chopper 2-1, when an excessive current flows in an arrow direction indicated in broken lines, damage may be caused by heat generation or the like. However, based on properties of a solar cell, when a current is less than or equal to a certain amount, even though the current or power flows in the reverse direction from the normal direction, the solar cell is not necessarily damaged. Further, there is also a case that a control apparatus in which direct current power from the step-up choppers 2-1 to 2-4 serves as a control power supply is used. In such a case, in order not to cause the current to flow in the reverse direction toward a solar cell string PV-1, when output from step-up choppers 2-2 to 2-4 that normally operate stops, there is a possibility that an operation of the control apparatus becomes unstable. The present disclosure is intended for preventing damage to a solar cell and using power from other solar cells by limiting the current or power flowing in the reverse direction toward the solar cell string PV-1 to a possible, small range. Although the control for achieving such a condition can be performed based on an indicator which is at least any of power, voltages or currents in the solar cell string PV-1 that are input from solar cell strings PV-2 to PV-4, power or voltages output from the solar cell strings PV-2 to PV-4 respectively, or duty ratios of PWM signals controlling drive of IGBTs 24-2 to 24-4 of the step-up choppers 2-2 to 2-4, it may be performed using other indicators.

### EXAMPLE

A power conversion apparatus according to an embodiment of the present disclosure will be described below in more details using the drawings.

<Configuration of Apparatus>

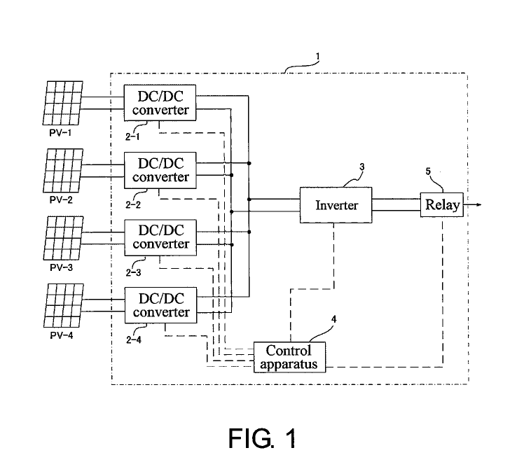

FIG. 1 is a schematic diagram of a solar cell system including a power conditioner 1 that is an example of a power conversion apparatus according to the present embodiment.

As shown in FIG. 1, in the power conditioner 1, a plurality of solar cell strings PV-1 to PV-4 are connected together. The power conditioner 1 includes DC/DC converters 2-1 to 2-4 converting a direct current voltage output from each of the solar cell strings PV-1 to PV-4 and an inverter 3 converting the converted direct current voltage into an alternating current voltage. The power conditioner 1 further includes a relay 5 that is an example of a turn-on and turn-off part for turning on and off a circuit connecting an output from the inverter 3 to a commercial power supply or a load that is not shown. The power conditioner 1 includes a control apparatus 4 controlling the DC/DC converters 2-1 to 2-4, the inverter 3 and the relay 5. In FIG. 1, although the four solar cell strings PV-1 to PV-4 are connected to each other in the power conditioner 1, the number of solar cell strings connected in parallel is limited thereto, and two or more of solar cell strings are sufficient.

FIG. 2 illustrates step-up choppers that are an example of the DC/DC converters 2-1 to 2-4 (connection to the solar cell string PV-1 or the like and the inverter 3 is omitted herein). The DC/DC converter is a structure converting a direct current voltage of a solar cell string into a predetermined direct current voltage and adjusting an operating point of the solar cell string, and is not limited to a step-down chopper. The step-up chopper 2-1 is connected to a P side and an N side of the solar cell string PV-1, wherein a current sensor 2-1-1 detecting a direction and a level of a current is provided on the P side. Output from the current sensor 21-1 is input to the control apparatus 4. A capacitor 22-1 is connected in parallel to an output side of the current sensor 21-1, and an inductor 23-1 is vertically connected to the P side. An IGBT 24-1 that is an example of a switching element is connected in parallel to an output side of the inductor 23-1. An antiparallel diode is connected to the IGBT 24-1. On an output side of the IGBT 24-1, a reflux diode 25-1 whose forward direction is along the output side from the solar cell string PV-1 is vertically connected to the P side, and the capacitor 26-1 is connected in parallel. In a gate of the IGBT 24-1, the control apparatus 4 is connected via a drive circuit 27-1, and a PWM control signal is supplied. Since configurations of the other step-up choppers 2-2 to 2-4 are also the same, the description about the same reference numeral (current sensors 21-2˜21-4, capacitors 22-2˜22-4, inductors 23-2˜23-4 [symbol] IGBTs 24-2˜24-4, reflux diodes 25-2˜25-4, capacitors 26-2˜26-4 and drive circuits 27-2˜27-4) will be omitted. In FIG. 2, although the capacitor 22-1 is connected to the output side of the current sensor 21-1, the current sensor 21-1 may connect in series with to the inductor 23-1 in a latter portion the capacitor 22-1.

If the step-up chopper 2-1 is in a normal state, a current, as shown by arrows indicated in solid lines, flows from a side of the solar cell string PV-1 to an output side by the reflux diode 25-1, and the flow of the current in the reverse direction toward the solar cell string PV-1 from the output side is stopped. However, for some reason, for example, when a short circuit occurs in the reflux diode 25-1 of the step-up chopper 2-1, the current flowing in the reverse direction from the normal direction toward the solar cell string PV-1 from the output side, as shown by arrows indicated in broken lines, is allowed. In such a case, in the other step-up choppers 2-2 to 2-4, the IGBTs 24-2 to 24-4 may be driven in the same way as in a normal state. Alternatively, when switching is stopped, it is possible that power output from the other step-up choppers 2-2 to 2-4, as shown by arrows indicated in broken lines, is input to the side of the solar cell string PV-1 via the step-up chopper 2-1. If power input to the solar cell string PV-1 is excessive, heat generation may cause damage. Although the case that a short circuit fault occurs in the reflux diode 25-1 of the step-up chopper 2-1 is described below, it is true of the case where a short circuit fault occurs in a diode of any step-up chopper and is true of the case where in a system where three or more solar cell strings are connected, there are diodes in which a short circuit fault has occurred, and at least one or more of other chopper portions are normally operating. Further, occurrence of the short circuit fault or information on a position of the fault or the like may be shown by a display unit that is not shown and is provided in the power conditioner 1, or a display unit at an end of a PC or the like connected via a network. Herein, a converter set 6 includes the DC/DC converters 2-2 to 2-4, i.e. the step-up choppers 2-2 to 2-4.

<Control Method>

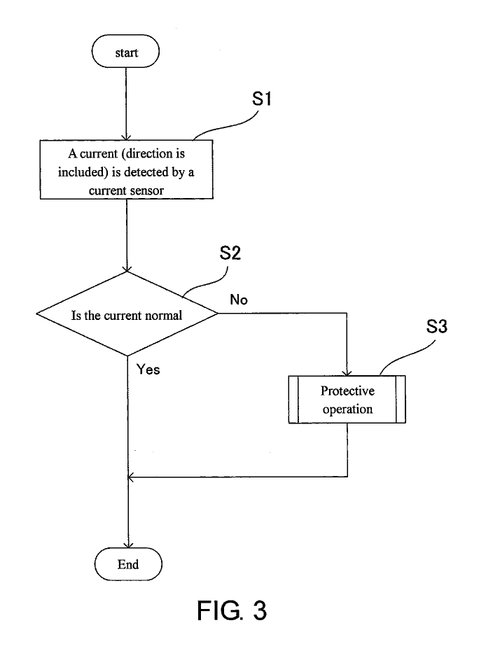

Therefore, in the present embodiment, in accordance with the procedure shown in the flowchart illustrated in FIG. 3, the power conditioner 1 is controlled. First, in step S1, a current (a direction thereof is included) is detected by the current sensors 21-1 to 21-4. Then, in step S2, whether or not the detected current is normal is determined. If the detected current is normal, it means that the detected current flows in a normal state. If the current is normal, the process is terminated. If the detected current is abnormal, that is, the current flowing in the reverse direction from the normal direction is detected, a predetermined protective operation subroutine is executed, and the process is terminated in step S3. The case where it is determined that the detected current is abnormal includes not only the case where the current flowing in the reverse direction from the normal direction is detected, but also the case where a current value is set based on a standard that the current flowing in the reverse direction is greater than or equal to a predetermined value is detected.

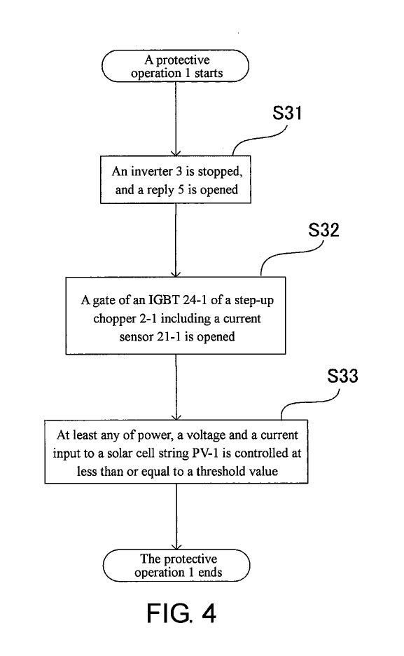

FIG. 4 illustrates a procedure of a protective operation 1 subroutine. Although the case that the current flowing in the reverse direction from the normal direction is detected in the current sensor 21-1 is detected is taken as example for illustrative purposes, it is also true of the case where the current is detected in the other current sensors 21-2 to 21-4.

First, the inverter 3 is stopped, and the relay 5 is opened (step S31).

Next, the gate of the IGBT 24-1 of the step-up chopper 2-1 is opened (off) (step S32), wherein the step-up chopper 2-1 includes the current sensor 21-1 in which a reverse current is detected.

The step-up choppers 2-2 to 2-4 that are normally operating are driven (step S33). At this time, the step-up choppers 2-2 to 2-4 are driven under the condition that at least any of power, a voltage or a current input from each of the solar cell strings PV-2 to PV-4 to the solar cell string PV-1 is set as less than or equal to a predetermined threshold value (first threshold value). A specific value of the predetermined threshold value can be set depending on a property like the extent to which the solar cell string PV-1 to which the power is input is not damaged. The step-up choppers 2-2 to 2-4 are driven by feedback control in a way that a current input to the solar cell string PV-1 is set as less than or equal to the predetermined threshold value, while a current value of the current sensor 21-1 is detected.

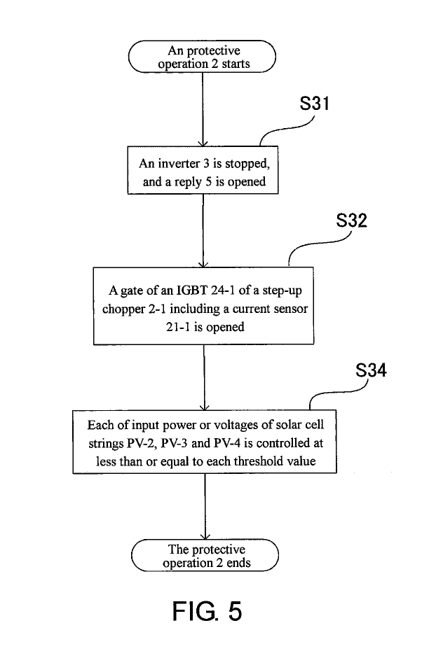

FIG. 5 illustrates a procedure of a protective operation 2 subroutine. Since steps S31 and S32 have the protective operation 1 in common, the explanation will be omitted therein. In step S34, in the protective operation 2 subroutine, the step-up choppers 2-2 to 2-4 are driven under the condition that power or a voltage output from each of the solar cell strings PV-2 to PV-4 is set as less than or equal to a respective predetermined threshold value (second threshold value). A specific value of the predetermined threshold value can be set depending on a property like the extent to which the solar cell string PV-1 to which the power or voltage is input is not damaged. Herein, the second threshold value specifically refers to a plurality of values set for each of the step-up choppers 2-2 to 2-4 and does not necessarily indicate a single value.

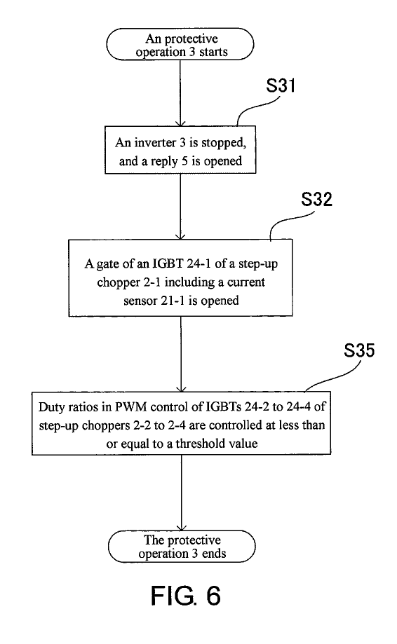

FIG. 6 illustrates a procedure of a protective operation 3 subroutine. Since steps S31 and S32 have the protective operation 1 subroutine shown in FIG. 4 in common, the explanation will be omitted therein. After step S32, the step-up choppers 2-2 to 2-4 that are normally operating are driven (step S35). At this time, in order to control drive of each of the IGBTs 24-2 to 24-4, the step-up choppers 2-2 to 2-4 are driven under the condition that duty ratios of PWM signals output from the control apparatus 4 are set as less than or equal to a predetermined threshold value (third threshold value) respectively. Each specific value of the predetermined threshold value can be set depending on a property like the extent to which the solar cell string PV-1 is not damaged by power from the step-up choppers 2-2 to 2-4. In the present embodiment, although PWM control is applied to the IGBTs 24-2 to 24-4, depending on the circuit type of the DC/DC converter, PFM control may be applied. Herein, the third threshold value specifically refers to a plurality of values set for each of the step-up choppers 2-2 to 2-4 and does not necessarily indicate a single value.

According to the above-mentioned control method, when a power supply of the control apparatus 4 is obtained from the step-up choppers 2-1 to 2-4, direct current voltages from the step-up choppers 2-2 to 2-4 can be used as a power supply of the control apparatus 4. That is, even though a short circuit fault occurs in any of the step-up choppers, a control power supply of the power conditioner 1 can be secured by using power from other solar cell strings via step-up choppers that are normally operating. Further, in such a case, a value that does not render an operation of the control apparatus 4 unstable from the above threshold values is selected.

For comparison of components of the present disclosure and configurations of embodiments, the components of the present disclosure are denoted by reference numerals in the drawings.

### <Disclosure 1>

The power conditioner (1) includes: the first DC/DC converter (2-1) connected to the first solar cell (PV-1); the converter set (6), being respectively connected to the first solar cell (PV-1) and second solar cells (PV-2 to PV-4) different from the first solar cell (PV-1) and including at least one second DC/DC converter (2-2 to 2-4) connected in parallel with the first DC/DC converter (2-1); and the control apparatus (4), controlling the first DC/DC converter (2-1) and the second DC/DC converter (2-2 to 2-4) of the converter set (6), wherein when a current flowing in the reverse direction from the normal direction is detected in the first DC/DC converter (2-1), the control apparatus (4) controls the second DC/DC converter (2-2 to 2-4) of the converter set (6) in a way that at least any of power, a voltage or a current in the first solar cell (PV-1) that is input from the converter set (6) is set as less than or equal to the predetermined first threshold value.

### <Disclosure 2>

In the power conditioner (1) of disclosure 1, when the current flowing in the reverse direction from the normal direction is detected in the first DC/DC converter (2-1), the control apparatus (4) controls the second DC/DC converters (2-2 to 2-4) of the converter set (6) in a way that power or voltages in the first solar cell second (PV-1) that are output from the second solar cells (PV-2 to PV-4) connected to the second DC/DC converters (2-2 to 2-4) of the converter set (6) respectively are set as less than or equal to the predetermined second threshold value respectively.

### <Disclosure 3>

In the power conditioner (1) of disclosure 2, the second DC/DC converters (2-2 to 2-4) of the converter set (6) have the second switching elements (24-2 to 24-4) controlled to be turned on and off depending on a control signal of the control apparatus (4), and when the current flowing in the reverse direction from the normal direction is detected in the first DC/DC converter (2-1), the control apparatus (4) performs control in a way that duty ratios of the control signals output from the control apparatus (4) to the second switching elements (24-2 to 24-4) are set as less than or equal to the third threshold value respectively.

### <Disclosure 4>

In the power conditioner (1) of any of disclosures 1 to 3, the first DC/DC converter (2-1) has the first switching element (24-1) controlled to be turned on and off depending on the control signal from the control apparatus (4), and when the current flowing in the reverse direction from the normal direction is detected in the first DC/DC converter (2-1), the control apparatus 4 turns off the first switching element (24-1).

### <Disclosure 5>

The power conditioner (1) of disclosure 4 includes the inverter (3) converting direct current power output from the first DC/DC converter (2-1) and the second DC/DC converters (2-2 to 2-4) of the converter set (6) into alternating current power, and when the current flowing in the reverse direction from the normal direction is detected in the first DC/DC converter (2-1), the control apparatus (4) stops the inverter (3).

### <Disclosure 6>

The power conditioner (1) of disclosure 5 includes a turn-on and turn-off part (5) for turning on and off the inverter (3) and a circuit connected to a commercial power supply or a load, and when the current flowing in the reverse direction from the normal direction is detected in the first DC/DC converter (2-1), the control apparatus (4) opens the turn-on and turn-off part (5).

What is claimed is:

1. A power conditioner, comprising:
a first DC/DC converter connected to a first solar cell;
a converter set, being respectively connected to the first solar cell and second solar cells different from the first solar cell and comprising at least one second DC/DC converter connected in parallel with the first DC/DC converter; and
a control apparatus, controlling the first DC/DC converter and the second DC/DC converter of the converter set, wherein when a current flowing in a reverse direction from a normal direction is detected in the first DC/DC converter, the control apparatus controls the second DC/DC converter of the converter set such that at least any of power, a voltage or a current in the first solar cell that is input from the converter set is set as less than or equal to a predetermined first threshold value.

2. The power conditioner of claim 1, wherein when the current flowing in the reverse direction from the normal direction is detected in the first DC/DC converter, the control apparatus controls the second DC/DC converters of the converter set such that power or voltages in the first solar cell that are output from the second solar cells connected to the second DC/DC converters of the converter set respectively are set as less than or equal to a predetermined second threshold value respectively.

3. The power conditioner of claim 2, wherein the second DC/DC converters of the converter set respectively have switching elements controlled to be turned on and off depending on control signals from the control apparatus, and when the current flowing in the reverse direction from the normal direction is detected in the first DC/DC converter, the control apparatus performs control such that duty ratios of the control signals output from the control apparatus to each switching element are set as less than or equal to a predetermined third threshold value respectively.

4. The power conditioner of claim 1, wherein the first DC/DC converter has a first switching element controlled to be turned on and off depending on the control signal from the control apparatus, and when the current flowing in the reverse direction from the normal direction is detected in the first DC/DC converter, the control apparatus turns off the first switching element.

5. The power conditioner of claim 2, wherein the first DC/DC converter has a first switching element controlled to be turned on and off depending on the control signal from the control apparatus, and when the current flowing in the reverse direction from the normal direction is detected in the first DC/DC converter, the control apparatus turns off the first switching element.

6. The power conditioner of claim 3, wherein the first DC/DC converter has a first switching element controlled to be turned on and off depending on the control signal from the control apparatus, and when the current flowing in the reverse direction from the normal direction is detected in the first DC/DC converter, the control apparatus turns off the first switching element.

7. The power conditioner of claim 4, comprising:
an inverter, converting direct current power output from the first DC/DC converter and the second DC/DC converter of the converter set into alternating current power, wherein when the current flowing in the reverse direction from the normal direction is detected in the first DC/DC converter, the control apparatus stops the inverter.

8. The power conditioner of claim 5, comprising:
an inverter, converting direct current power output from the first DC/DC converter and the second DC/DC converters of the converter set into alternating current power, wherein when the current flowing in the reverse direction from the normal direction is detected in the first DC/DC converter, the control apparatus stops the inverter.

9. The power conditioner of claim 6, comprising:
an inverter, converting direct current power output from the first DC/DC converter and the second DC/DC converters of the converter set into alternating current power, wherein when the current flowing in the reverse direction from the normal direction is detected in the first DC/DC converter, the control apparatus stops the inverter.

10. The power conditioner of claim 7, comprising:
a turn-on and turn-off part for turning on and off the inverter and a circuit connected to a commercial power supply or a load, wherein when the current flowing in the reverse direction from the normal direction is detected in the first DC/DC converter, the control apparatus opens the turn-on and turn-off part.

11. The power conditioner of claim 8, comprising:
a turn-on and turn-off part for turning on and off the inverter and a circuit connected to a commercial power supply or a load, wherein when the current flowing in the reverse direction from the normal direction is detected in the first DC/DC converter, the control apparatus opens the turn-on and turn-off part.

12. The power conditioner of claim 9, comprising:
a turn-on and turn-off part for turning on and off the inverter and a circuit connected to a commercial power supply or a load, wherein when the current flowing in the reverse direction from the normal direction is detected in the first DC/DC converter, the control apparatus opens the turn-on and turn-off part.
